(19) United States
(12) Patent Application Publication
(10) Pub. No.: US 2012/0012576 A1
(43) Pub. Date: Jan. 19, 2012

(54) METHOD FOR PRODUCING A TOOL-SYSTEM MODULE

(75) Inventors: Jochen BITZER, Albstadt-Truchtelfingen (DE); Steffen Klaus Lang, Albstadt-Tailfingen (DE)

(73) Assignee: Guehring OHG, Albstadt (DE)

(21) Appl. No.: 13/158,036

(22) Filed: Jun. 10, 2011

Related U.S. Application Data
(63) Continuation of application No. PCT/DE2009/001791, filed on Dec. 21, 2009.

(30) Foreign Application Priority Data
Dec. 23, 2008 (DE) 10 2008 062 920.0

(51) Int. Cl. H05B 6/10

(52) U.S. Cl. 219/635

(57) ABSTRACT

The invention relates to a method for producing a tool-system module, such as a tool having brazed blades (PKD, CBN or hard metal), wherein a cylindrical blank is equipped at an axial end with a conical hollow shaft (HSK), in particular according to DIN 69893. Select functional areas undergo a hardening process. The hardening step is carried out according to the induction hardening method and integrated in the continuous manufacturing line of the tool-system module.

The invention relates to a method for producing a tool system module, in particular, for example, a rotationally-driven metal-cutting special tool, in which a cylindrical blank is equipped on one axial end with a hollow taper shank (HSK), in particular a hollow taper shank according to DIN 69893.

The so-called HSK interface has become more and more widespread in recent time in tool chucking. This interface is standardized in DIN 69893 and is distinguished in that the tool or the tool system module attached via the interface is radially positioned particularly precisely, and particularly high torques can be transmitted between receptacle and attached tool system module. An extremely high level of friction lock arises through the design of the standardized hollow taper shank in connection with the chucking elements engaging inside the hollow taper shank (HSK) over the entire taper lateral surface on one side and the additionally provided planar contact surface. In most cases—with the exception of the construction E according to DIN 69893-5—two slot nuts at the shank end of the tool receptacle engage in the tool and ensure formfitting and defined radial positioning in this way.

In comparison to the typical so-called “steep taper”, the hollow shank interface (HSK), which has found wide distribution in the meantime in the field of machining, has particular advantages with respect to precision, rigidity, and the suitability for very high speeds, with the further advantage that rapid tool changes are also possible. Because of the special design features of the HSK interface, however, it is to be extremely precisely ensured during the production that the limiting carrying capacity is not exceeded in the entire usage spectrum of the interface. In addition, this is made more difficult, for example, because if the hollow taper shank is implemented directly on a tool (for example on a tool having an eroded or ground plate seat or on a tool having brazed blades (PKD, CBN, hard metal (HM)), only special materials can be used, such as quenched and tempered or case-hardened steels, so that the manufacturing expenditure can be significant.

In addition, it is particularly significant that the strain of the hollow taper shank, in particular in the transition area to the tool shank, already varies from tool to tool solely because of the different shank lengths. Depending on which tool is used, the bending torque induced by the cutting force varies, so that the lateral force carrying capacity of the hollow taper shank varies relatively strongly as a function of the protruding length of the tool blades. The torsion fatigue strength of the interface design is also an essential criterion for the success of the interface.

In the real metal-cutting process, the interface is subjected to a dynamic excitation which reduces the transmittable and bearable torsion torque over a long period of time. Therefore, it is important during the production of the components for the HSK interface to produce the functional surfaces which are functionally engaged having very precise dimensions, in such a way that no impermissible dimensional deviations result over the service life of the components. For this reason, DIN 69893 prescribes, inter alia, the points at which hardening of the surface must be performed.

In the typical production process, firstly a cylindrical blank made of tool steel is processed having a predetermined excess to form the hollow taper shank. This semifinished product is then taken from the metal-cutting process and—frequently externally—provided for hardening. The tools hardened in the area of the HSK are then introduced back into the metal-cutting manufacturing process and machined to the final dimensions.

Neglecting the fact that this process is time-consuming and costly, the following has been shown:

Hollow taper shanks sometimes fracture in the use of the tool, the causes of the material failure not being able to be explained in many cases. One problem in is that a plurality of materials must be used for the tools and therefore also for the hollow taper shank, and the distribution of the microstructure over the cross-section cannot be “viewed” for the component, which is introduced back into the metal-cutting manufacturing process after the hardening. Correspondingly, during the following final machining, for example, during the grinding of the functional surfaces of the hollow taper shank, thermal strain of the material can occur, which can be harmful with respect to fatigue strength and cracking sensitivity.

The invention is therefore based on the object of providing a method for producing a tool system module, in particular, for example, a metal-cutting special tool, using which it is possible to produce the hollow taper shank (HSK) having improved quality and service life.

This object is achieved by the features of Claim 1.

According to the invention, the method is distinguished by two primary novel features. On the one hand, selected functional areas of the hollow taper shank are subjected to an induction hardening method. On the other hand, the method step of hardening is integrated into the continuous manufacturing process line of the tool system module.

Not only are time and costs saved by these measures. The special advantage is particularly that microstructure or hardening flaws can be effectively prevented. Through the incorporation in the manufacturing process, it is more or less no longer possible to confuse the tool steel or to make treatment errors, for example, to perform insufficient or excessively deep hardening or to perform underhardening. The special advantage results that the hardening depth, on the one hand, but also the heating depth can be controlled precisely in the process by the induction hardening method, so that it is possible to treat the material of the hollow taper shank for the respective stress. In this way, it is possible in particular to substantially improve the crack sensitivity of the microstructure, but simultaneously also to prevent boundary cool spots from occurring.

Advantageous refinements of the invention are the subject matter of the subclaims.

Precise machining having particularly reliable processing results using the refinement of the method according to Claim 2. In this way, lead times are shortened and a minimum space requirement and simple setting, refitting, and maintenance of the manufacturing line additionally result. Finally, the number of error sources during the production process is reduced. The machining of the workpiece blank is typically performed in a material-oriented way. Through the integration of the production process in the manufacturing process line, errors during the adaptation of the hardening process to the respective provided material of the hollow taper shank are substantially prevented. Since smaller deformations of the workpiece additionally result during the induction hardening, the dimensions of the hollow taper shank before the hardening can be kept smaller than was heretofore required. This in turn results in the possibility of controlling the hardening depth more precisely down to the 1/10 mm range, whereby the tendency is for more cross-section to remain for the formation of more ductile material microstructure.

The limit carrying capacity of the HSK interfaces (forms A, B, and C) according to DIN 69893-1 and ISO 12164-1 (as specified, for example, in the VDMA unit sheet number 34181) can be reliably maintained in this way for all common diameters of the HSK (e.g., HSK-A32 up to HSK-A100) and for all common tool module lengths or tool lengths.

To integrate the induction hardening in the manufacturing process, it can be advantageous, for example, to operate using hardening robots, as are described, for example, in facilities for inductive heat treatment of EFD Induction GmbH, Freiburg im Breisgau, under the name “HardLine”. It is similarly possible to operate using hardening process module units as have been marketed, for example, by Plustherm Point GmbH, Wettingen, Switzerland.

Particularly good results may be achieved by the refinement of Claim 3. Because certain surface areas of the hollow taper shank are only subjected to boundary layer hardening, the core microstructure remains substantially uninfluenced in this section. The workpieces are heated in the so-called hardening zone to hardening temperature, so that a type of “heat buildup effect” occurs there. In other words, more energy is supplied in this hardening zone per unit of time than can flow out toward the workpiece middle. The core microstructure can remain uninfluenced in this way, the additional advantage of the so-called “skin effect” being utilized during the induction hardening. The energy supply by resistance heating grows with the square of the frequency, while the energy supply because of the hysteresis losses rises linearly. The current density on the workpiece surface also increases with rising frequency (skin effect). The penetration depth of the currents is thus frequency-dependent. The amount of energy which can be supplied per unit of time during the induction heating is approximately 10 times as great as in the case of flame hardening, so that the hardening depth may be varied in wide limits by the holding time at the hardening temperature and with a time delay until quenching.

Through suitable selection of the heat introduction, i.e., through targeted control of the parameters of the induction hardening process in consideration of the following formula for the idealized penetration depth of the current:

$$Δ = 503 \cdot \sqrt{\frac{ρ}{{μ}_{r} \cdot f}} [ mm ]$$

where
Δ=penetration depth
ρ=specific resistance [Ω·mm³/m]
μᵣ=relative permeability
f=frequency [Hz],
   the desired microstructure can be set optimally at every specific location of the hollow taper shank with greater processing speed and processing precision.

With the refinement of Claim 5, the hardening process is advantageously combined with a further treatment of the material, in order to adapt at least selected areas of the hollow taper shank with respect to microstructure to the long-term strain to be expected there. Fundamentally, the induction hardening can be performed according to all typical methods, thus, for example, according to the sheath hardening method or according to the line hardening method. In so-called sheath hardening, the surface to be hardened is completely heated and subsequently quenched. In line hardening, in contrast, heating source and quenching spray run coupled one behind the other. It is also similarly possible to operate using a combined method. It can also be advantageous to associate a separate inductor head with or without integrated spray unit to each hollow taper shank of a specific construction, in order to achieve the desired microstructure distribution.

Any steel which can be induction hardened can be used as the material for the tool system modules, in particular quenched and tempered steel having sufficient carbon content (preferably between 0.35 and 0.7%), tool steel, rustproof steel, or roller bearing steel. A table of suitable steels is found, for example, in the article “Partielle Härte/Randschichthärten lässt Kerngefüge unbeeinflusst [Partial Hardening/Boundary Layer Hardening Leaves Core Microstructure Uninfluenced]” by Dipl.-Ing. U. Reese, Bochum; published in the Industrieanzeiger special issue number 83, pages 52 to 53. Further materials are, for example, quenched and tempered steels of the following material designations: C45, C35, 42CrMo4, C60, 56NiCrMoV7, X38CrMoV5-1, 16MnCr5, 16MnCrS5, 31CrMoV9, X38CrMoV5-1, tool steel according to the designation 50NiCr13, but also diverse types of stainless steel, such as 60MnSiCr4.

Various possibilities also come into consideration for the inductor constructions. Thus, for example, a ring inductor having internal field or, for the hardening of the inner surfaces or selected areas of the inner surface of the hollow taper shank, a ring inductor having external field can be used. The hardening procedure can also be regionally performed using a total surface inductor or using a linear inductor.

The hardening depth can be controlled within wide limits, and it is preferably in the range between 0.05 mm up to several millimeters. The steel which is suitable for the induction hardening can also be selected from DIN 17212.

Because of the incorporation into the manufacturing process, a production method having high repetition precision results, particularly because all processing variables can be controlled via a central machine controller. It is even possible to integrate testing methods in the process of the production of the hollow taper shank, which ascertain the hardness of selected areas following the hardening process.

The invention is explained in greater detail hereafter on the basis of schematic drawings. In the figures:

FIG. 1 shows a side view in partial section of a hollow taper shank according to DIN 69893-1;

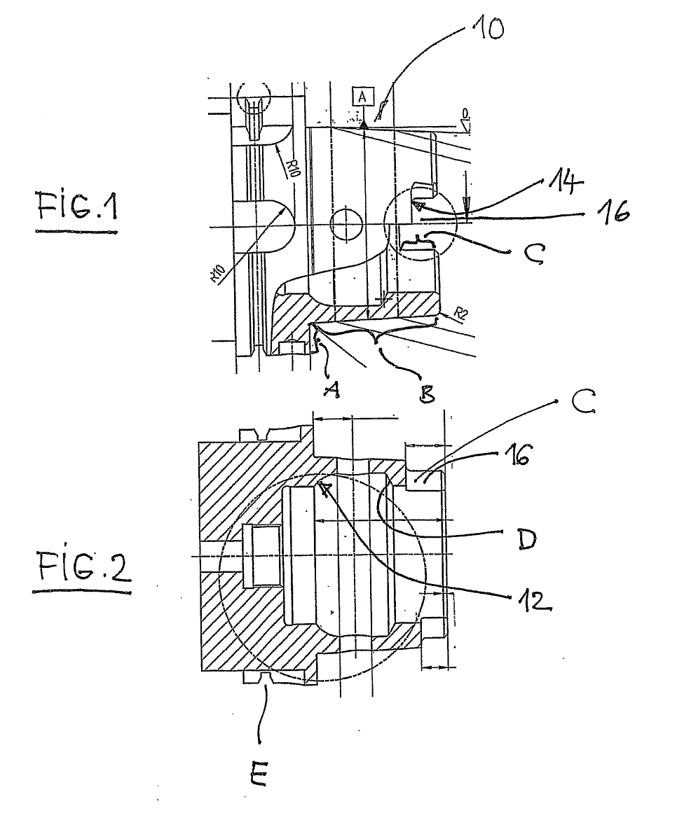

FIG. 2 shows the sectional view along II-II in FIG. 1;

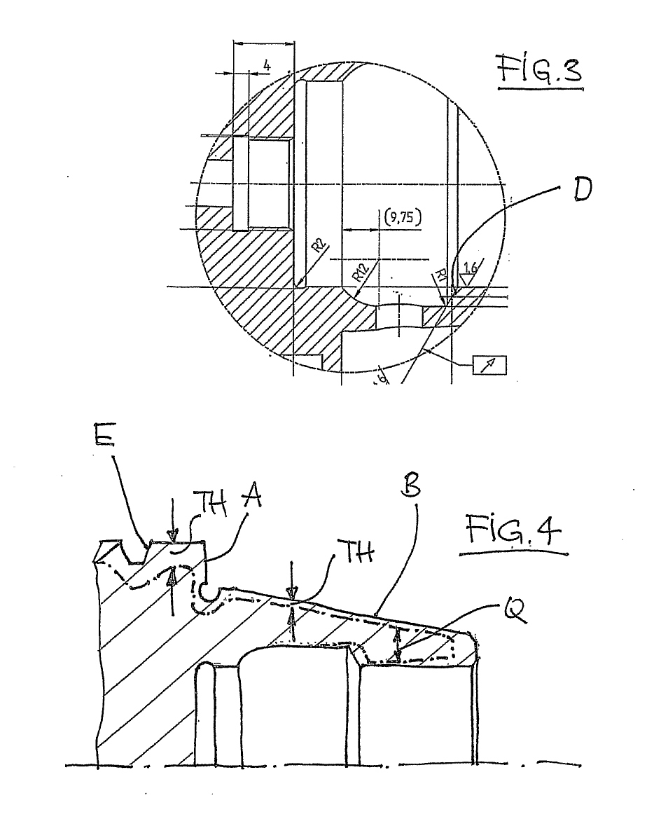

FIG. 3 shows detail “III” in FIG. 2; and

FIG. 4 shows—in a somewhat enlarged view—a schematic partial sectional view of a hollow taper shank after the hardening process.

FIG. 1 shows a view to scale of a hollow taper shank 10 having the designation HSK-A100 according to DIN 69893-1 (May 2003). The hollow taper shank (HSK) is implemented here, for example, on a rotationally-driven metal-cutting tool having eroded or ground plate seat with chucking thread, on a tool having milled plate seat, or on a tool having brazed blades, which can be formed by PKD, CBN, or hard metal (HM) blades. However, it is already to be emphasized here that the hollow taper shank can also be implemented on tool holders without blades or also in so-called “base receptacles” such as flanges or reductions or extensions. Finally, it is also possible to implement such hollow taper shanks (HSK) on plate tools having other shanks.

General requirements for replacing tool holders having hollow taper shanks according to DIN 69893-1, form A and form C, in the operating spindle of machine tools, such as processing centers, turning, drilling, milling, and grinding machines, are established in DIN 69882-1. If not otherwise specified in the relevant product standard, the tensile strength of the steel used is at least 800 N/mm². Furthermore, the hardened surface sections are specified as 56+4 HRC or 590+80 HV30.

The special feature of the hollow taper shank 10 of this construction is that various functional surfaces, which are identified by A, B, C, D, and E in FIGS. 1 to 4, are subjected to different strains:

A fixed axial planar contact to the counterpart of the HSK interface occurs on the radial front faces A. The radial surface contact is provided in the area of the outer cone B, a radial elastic pre-tension of the cone section occurring due to the excess between cone and receptacle. In the area of the section C, slot nuts (not shown) engage with a fit to further increase the maximum transmittable torque.

According to DIN 69893-1, at least 75% of the clamping force which acts via internal jaws (also not shown) on the internal wedge surface D must act on the planar contact surface A. Finally, in the area E, i.e., in the area of a gripper groove, a specific surface quality is also required to keep wear by tool replacement systems small.

All functional surfaces A to E are to be implemented as hardened, so as not to permit excess wear to occur over the service life of the tool. However, a fundamentally differing strain profile is provided in the area of the functional surfaces A to D or E, so that it is desirable to form the hardened surfaces in such a way that the respective cross-section provided there increases optimally for the strains.

Tension maxima under the influence of speed typically form in the area of a transition radius 12 between clamping bevel and shank internal diameter and in the slot base radius 14 of the deep driver slot 16. The limiting speed of the HSK interface is thus determined, inter alia, by the length of the supporting receptacle, the radial excess between shank and receptacle, and by the external dimensions of the receptacle and by the respective metal-cutting system used. Correspondingly, it is decisive from case to case that the manufacturing process of the hollow taper shank (HSK) 10 is optimally adapted to the relevant later field of use.

This is achieved according to the invention in that at least selected areas of the sections A to E are surface-hardened, i.e., according to the induction hardening method. Induced eddy current is used in this case, which is induced in the metal material by a time-variant magnetic field. The areas of the workpiece permeated by the eddy currents heat up because of their ohmic resistance. In the case of ferromagnetic metals, heating additionally occurs because of hysteresis losses. The eddy currents are increasingly concentrated on the conductor surface with rising frequency (skin effect). Because of the skin effect and the fact that the strength of the magnetic field decreases with increasing spacing from the inductor, the eddy currents remain restricted to a layer close to the surface, so that typically only the boundary layer of the workpiece is heated to hardening temperature during the induction hardening.

Heating of the boundary layer to be subjected to the hardening process can be varied as needed using suitable magnetic flux concentrators and suitable design of the inductors. This is also true for the following quenching, i.e., for the subsequent withdrawal of heat. After the electro-inductive heating of the boundary layer to hardening temperature, it is quenched using a spray flushed with coolant medium. During heating, a homogeneous mixed crystal, the austenite, is formed from the originally provided cementite-ferrite crystal mixture. The carbon which was bound in the cementite (Fe₃C) is atomically dissolved in the austenite. The following cooling must thus occur so rapidly that the carbon remains dissolved even after the crystal conversion, and the conversion of the austenite to perlite and ferrite is suppressed, whereby the hardening microstructure martensite arises.

A further special feature of the method according to the invention is integrating the step of induction hardening in the continuous manufacturing process line of the tool or the tool system module. In other words, the material parameters and the geometry parameters are input into the process control system. The hardening module of the process, for example, in the form of a robot having an inductor manipulator arm, thus has this system-intrinsic data available either from the beginning or through data transfer. Correspondingly, exact values for the microstructure to be achieved at selected positions of the hollow taper shank are established for each workpiece currently subjected to the processing. Correspondingly, the inductor can be controlled with respect to movement, amperage, and frequency, on the one hand, and the quenching spray can be controlled with respect to time delay and cooling power, on the other hand, so that the target microstructure is achieved at every decisive point.

It is possible in this way, for example, to control the hardness depth TH in the area of the functional surfaces of the hollow taper shank as schematically indicated in FIG. 4. The boundary between the hardened microstructure and the zone uninfluenced by heat is identified by the dot-dash line. It may be seen that this hardness depth TH can change in wide limits over the surface of the hollow taper shank. While it can be comparatively great in the area of the gripper groove E, it is only in the 1/10-mm range in the area of the outer cone B. In the area of the slots 16 for the engagement of the driver slot nuts (not shown), it can also be greater, as in the area of the cone surface D, while it can disappear entirely in the area of the transition radius 12.

In other words, the area of the material microstructure uninfluenced by the hardening process, which is identified by the double arrow Q in FIG. 4, can be controlled according to the individual tension curves and strain conditions to be expected in later use of the tool, in order to fully exhaust the ductility of the material where it is required in this way, so that the service life of the tool or the tool system module can be increased reproducibly.

It is obvious that processing errors can be minimized using the design of the production method according to the invention. Because the hardening procedure is incorporated into the manufacturing process line, the parameters with respect to geometry and material microstructure are already present in the system at the beginning of the hardening procedure. Transmission errors of such data are therefore prevented. The processing reliability during hardening is perceptibly raised in this way, the additional advantage resulting that through suitable measuring systems, fine tuning of the hardening procedure to the respective existing actual dimensions of the workpiece to be hardened can even be performed.

Of course, deviations from the embodiment are possible without leaving the basic idea of the invention. Thus, for example, the hardening procedure can be combined with a further heat treatment step, in that the microstructure is then controlled and additionally influenced on selected areas.

Through the use of so-called magnetic flux concentrators, it can be ensured that the heat introduction into the material occurs in such a way that adjacent areas are influenced as little as possible. In this way, microstructure reconversions can be eliminated within broad limits.

Such magnetic flux concentrators can also be used in a time-controlled way, in order to keep the axial velocity of the inductor equal—for example, during line hardening—and thus simplify the process. Depending on the field of use, the hardness depth TH can also vary in wide limits. It can be between 0.05 mm and several milliliters.

Instead of the performance of the hardening procedure in the context of complete processing, preferably in a chuck, the method can also be performed so that the hardening process is performed in a processing module, which is then preferably coupled with respect to data to the manufacturing process line.

Is also possible in the scope of the production process to operate using sensors which continuously detect the processing parameters, in particular temperature of the workpiece surface, inductor voltage, frequency, and power, and regulate them according to a predefined profile.

The invention thus provides a method for producing a tool system module, such as a tool having brazed blades (PKD, CBN, or hard metal), in which a cylindrical blank is equipped on one axial end with a hollow taper shank (HSK), in particular according to DIN 69893. Selected functional areas are subjected to a hardening method. The method step of hardening is performed according to the induction hardening method and integrated in the continuous manufacturing process line of the tool system module.

1. A method for producing a tool system module, comprising a cylindrical blank equipped on one axial end with a hollow taper shank, selected functional areas subjected to a hardening method, the hardening method performed according to the induction hardening method and is integrated in the continuous manufacturing process line of the tool system module.

2. The method according to claim 1, wherein the method step of induction hardening is performed in the scope of complete processing.

3. The method according to claim 1, wherein at least selected areas of the hollow taper shank are subjected to the method of boundary layer hardening.

4. The method according to claim 1, wherein the hardening depth is controlled as a function of the strain profile of the respective cross-section provided at the point of the hollow taper shank to be hardened.

5. The method according to claim 1, wherein the method step of induction hardening is combined with a further heat treatment step.

6. The method according to claim 1, wherein the method step of induction hardening is performed according to the sheath hardening method at least on selected areas of the hollow taper shank.

7. The method according to claim 1, wherein the method step of induction hardening is performed according to the line hardening method at least on selected areas of the hollow taper shank.

8. The method according to claim 1, wherein the inductive heating of the sections of the hollow taper shank to be hardened is performed using magnetic flux concentrators.
